(19) United States
(12) Patent Application Publication
(10) Pub. No.: US 2023/0260398 A1
(43) Pub. Date: Aug. 17, 2023

(54) System and a Method for Reducing False Alerts in a Road Management System

(71) Applicant: Hong Kong Applied Science And Technology Research Institute Co., Ltd., Shatin (HK)

(72) Inventors: Zigan Zhou, Tai Po (HK); Dongzhe Su, Guangdong (CN); Hang Chen, Kowloon Bay (HK); Shijun Fan, Fanling (HK)

(21) Appl. No.: 17/673,506

(22) Filed: Feb. 16, 2022

(51) Int. Cl. G08G 1/09

(52) U.S. Cl. CPC G08G 1/091; H04W 4/40

(57) ABSTRACT

An area alert management system (AAMS) for reducing false alerts in a road management system comprises a map data unit comprising map data for a defined geographical area. The defined geographical area includes at least one roadside unit (RSU) configured to receive data from one or more vehicle on-board data processing units. An alert analysis unit of the AAMS receives vehicle generated alerts. The AAMS includes a static environment data unit comprising static environmental data for said defined geographical area. Upon receiving a vehicle generated alert, the alert analysis unit uses a location associated with the vehicle generated alert to obtain data from any of the map data unit, the static environment data unit or sensor data and determines if the received vehicle generated alert is consistent with the obtained data. If not consistent, the alert is determined as a false alert.

### FIELD OF THE INVENTION

The invention relates to a system and a method for improving road safety and/or management and, more particularly, but not exclusively, to a system for reducing false alerts in a road management system.

### BACKGROUND OF THE INVENTION

Vehicle-to-Everything (V2X) is a vehicular communication system configured to deliver information from a vehicle to any entity that may affect the vehicle, and vice versa. The system incorporates other more specific types of communications including, but not limited to, Vehicle-to-Infrastructure (V2I), Vehicle-to-Vehicle (V2V), Vehicle-to-Pedestrian (V2P), Vehicle-to-Device (V2D), and Vehicle-to-Grid (V2G).

Conventionally, vehicle on-board data processing units have typically been configured to use only real-time data retrieved from on-board vehicle modules to determine or detect threats and/or to generate safety alarms for vehicle users and/or other near-by road users. Consequently, in known systems, the threat detections and/or alarm determinations are based on only in-vehicle localized information. Such systems do not normally utilize a vehicular communication system such as V2X to manage communications for information and/or data exchange between vehicle on-board data processing units and, for example, roadside infrastructure for road safety and/or threat determination purposes.

One problem encountered in road management systems, whether V2X based systems or not, is the generation of false alerts by vehicles. Such false alerts may arise for any of a number of reasons such as, for example, a vehicle entering a defined geographical area for a first time lacking or absent up to date map data, lack of environmental data, and/or local alert data for the defined geographical area, inconsistent sensor data inputs, incorrect processing of sensor data by the vehicle on-board data processing units, lack or absence of other vehicle data such as location, speed, altitude, etc. False alerts not only result in a poor user experience, but, more importantly, may lead to safety issues for the vehicle users and could lead to users ignoring alerts presuming such alerts to be false alerts.

U.S. Pat. No. 8,604,967B1 discloses a vehicle safety system which collects data using an in-vehicle radar and generates alerts based on collected data relating to nearby vehicles' detected speeds and distances.

WO2019/052357A1 discloses a driving risk analysis system which divides a vehicle's forward direction area into first, second and third regions and determines risk by region. This greatly increases computational requirements as the forwards regions can change considerably with vehicle speed.

CN112885147A discloses a vehicle safety warning system for when a vehicle has broken down and using only in-vehicle sensor data processing.

US2018/0310147A1 discloses a method of transmitting and receiving an alert in a V2X communication system. An alert message contain rating information for an alert is transmitted. prior to transmitting a message containing information of the event relating to the alert.

CN112824185A discloses a collision early warning system.

CN112233414A discloses a V2X-based abnormal vehicle early warning method.

US2020/0186979A1 discloses a V2X based early warning system which determines an alert based on a vehicle's location and speed

CN111899562A discloses a system for issuing alerts relating to a curved road blind area.

US2021/0107402A1 discloses a system for warming of a vehicle in violation of a traffic signal.

U.S. Pat. No. 10,019,299B1 discloses a V2X communication apparatus including means for verifying reliability of V2X data.

Despite the foregoing disclosures, there remains a need for enhancing alert generation and/or threat detection for vehicular road safety and/or management purposes by using multiple sources of information such as vehicles, roadside infrastructure, communications network, etc. preferably with low latency communication of information and/or by reducing the occurrence of vehicle generated false alerts.

### OBJECTS OF THE INVENTION

An object of the invention is to mitigate or obviate to some degree one or more problems associated with known systems and methods of improving vehicular road safety and/or management of vehicles and/or of reducing the occurrence of vehicle generated false alerts.

The above object is met by the combination of features of the main claims; the sub-claims disclose further advantageous embodiments of the invention.

Another object of the invention is to provide a vehicular communication system based on a defined local geographical area for reducing vehicle generated false alerts within said defined local geographical area.

Another object of the invention is to provide an end-to-end V2X network system and method for reducing vehicle generated false alerts.

Another object of the invention is to provide a multi-tiered system and method for improving road safety and/or management of a vehicle where a local level tier of the multi-tiered system operates at the lowest latency level compared to other higher-level tiers.

One skilled in the art will derive from the following description other objects of the invention. Therefore, the foregoing statements of object are not exhaustive and serve merely to illustrate some of the many Objects of the present invention.

### SUMMARY OF THE INVENTION

For enhancing safety alarm generation and/or threat detection accuracy for vehicles, for example, multiple sources of information such as vehicles, pedestrian devices, roadside infrastructure, and communications network(s), etc. are required at preferably low latency signal processing and delivery levels. In one embodiment, the present invention provides an area alert management system (AAMS) for reducing false alerts in a road management system. The AAMS comprises a map data unit comprising map data for a defined geographical area. The defined geographical area includes at least one roadside unit (RSU) configured to receive data from one or more vehicle on-board data processing units. An alert analysis unit of the AAMS receives vehicle generated alerts. The AAMS preferably includes a static environment data unit comprising static environmental data for said defined geographical area. Upon receiving a vehicle generated alert, the alert analysis unit uses a location associated with the vehicle generated alert to obtain data from any of the map data unit, the static environment data unit or sensor data and determines if the received vehicle generated alert is consistent with the obtained data. If not consistent, the alert is determined as a false alert.

The AAMS generates the false alert map data or updates the false alert map data and communicates the false alert and/or the false alert map data to the at least one RSU which then broadcasts to the vehicle on-board data processing units. Equipped with the broadcast information; vehicles can locally make a decision in a manner which reduces or may even prevent the occurrences of false alerts. Consequently, vehicle can make a decision based not only on its local awareness of the environment but also taking into account data relating to false alerts previously generated by other vehicles and/or user devices thereby enabling the occurrences of such false alerts to be at least reduced.

In another embodiment, the present invention provides an end-to-end V2X network system having a multi-tier system architecture which utilizes information and algorithms performed at different tiers of the V2X network system to enable low latency generation of vehicle/road safety alarms and/or low latency determination of vehicle/road threats.

The invention therefore generally relates to a Vehicle-to-Everything (V2X) software system for improving road safety and/or management and, more particularly, but not exclusively, to a multi-tier V2X software system to reduce vehicle generated false alerts and preferably also to enable low latency road safety V2X alarm detection/threat determination at a local level whilst using information and algorithms performed at different higher level tiers of the system operating at different, higher latency levels.

In a first main aspect, the invention provides an area alert management system (AAMS) for reducing false alerts in a road management system, the AAMS comprising: a map data unit comprising map data for a defined geographical area, said defined geographical area including at least one roadside unit (RSU) configured to receive data from one or more vehicle on-board data processing units of vehicles located within said defined geographical area, said one or more vehicle on-hoard data processing units configured to autonomously determine alerts; an alert analysis unit configured to receive vehicle generated alerts; and a static environment data unit comprising static environmental data for said defined geographical area; wherein the AAMS is configured to receive data from a plurality of sources located within said defined geographical area; wherein, upon receiving a vehicle generated alert, the alert analysis unit is configured to: use a location associated with the vehicle generated alert to obtain map data from the map data unit for a defined area surrounding the vehicle generated alert location and/or use a location associated with the vehicle generated alert to obtain static environmental data for the defined area surrounding the vehicle generated alert location and/or retrieve sensor data for the defined area surrounding the vehicle generated alert location based on the location and time of the vehicle generated alert; determine if the received vehicle generated alert is consistent with the obtained and/or retrieved data for the defined area surrounding the vehicle generated alert location; and determine that the received vehicle generated alert is a false alert if a determination is made that the received vehicle generated alert is not consistent with the obtained and/or retrieved data for the defined area surrounding the vehicle generated alert location.

In a second main aspect, the invention provides an area alert management system (AAMS) for reducing false alerts in a road management system, the AAMS comprising: a map data unit comprising map data for a defined geographical area, said defined geographical area including at least one roadside unit (RSU) configured to receive data from one or more vehicle on-board data processing units of vehicles located within said defined geographical area, said one or more vehicle on-board data processing units configured to autonomously determine alerts; and an alert analysis unit configured to receive vehicle generated alerts; wherein, upon receiving a vehicle generated alert, the alert analysis unit is configured to: use a location associated with the vehicle generated alert to obtain map data from the map data unit for a defined area surrounding the vehicle generated alert location; determine if the received vehicle generated alert is consistent with map data for the defined area surrounding the vehicle generated alert location; and determine that the received vehicle generated alert is a false alert if a determination is made that the received vehicle generated alert is not consistent with the map data for the defined area surrounding the vehicle generated alert location.

In a third main aspect, the invention provides a method of determining of an alert is a false alert in a road management system having an area alert management system (AAMS) including a map data unit comprising map data for a defined geographical area and a static environment data unit comprising static environmental data for said defined geographical area, the AAMS being configured to receive data from a plurality of sources located within said defined geographical area, said defined geographical area including at least one roadside unit (RSU) configured to receive data from one or more vehicle on-board data processing units of vehicles located within said defined geographical area, said one or more vehicle on-board data processing units configured to autonomously determine alerts, the method comprising the steps of: receiving a vehicle generated alert; using a location associated with the vehicle generated alert to obtain map data from the map data unit for a defined area surrounding the vehicle generated alert location and/or using a location associated with the vehicle generated alert to obtain static environmental data for the defined area surrounding the vehicle generated alert location and/or retrieving sensor data for the defined area surrounding the vehicle generated alert location based on the location and time of the vehicle generated alert; determining if the received vehicle generated alert is consistent with the obtained and/or retrieved data for the defined area surrounding the vehicle generated alert location; and determining that the received vehicle generated alert is a false alert if a determination is made that the received vehicle generated alert is not consistent with the obtained and/or retrieved data for the defined area surrounding the vehicle generated alert location.

The summary of the invention does not necessarily disclose all the features essential for defining the invention; the invention may reside in a sub-combination of the disclosed features.

### BRIEF DESCRIPTION OF THE DRAWINGS

The foregoing and further features of the present invention will be apparent from the following description of preferred embodiments which are provided by way of example only in connection with the accompanying figures, of which:

FIG. 1 is a schematic diagram illustrating one embodiment of a road management system;

FIG. 2 is a schematic diagram of the system of FIG. 1 showing said system comprising an end-to-end V2X network;

FIG. 3 is a schematic diagram of the system of FIG. 1 shoving more clearly the tiered structure of said system;

FIG. 4 is a block diagram showing the structure of an edge gateway module for the system of FIG. 1 and illustrating its connections to other entities and some of its information/data inputs;

FIG. 5 is a block diagram showing the structure of a network cooperation engine (NCE) module for the system of FIG. 1 and illustrating its connections to other entities and some of its information/data inputs;

FIG. 6 is a block diagram showing the structure of a central management platform module for the system of FIG. 1 and illustrating its connections to other entities;

FIG. 7 is a flow diagram of the information flows and processes performed by an edge gateway module for the system of FIG. 1;

FIG. 8 is a flow diagram of the information flows and processes performed by a NCE module for the system of FIG. 1;

FIG. 9 illustrates an example of how a vehicle generated false alert may arise;

FIG. 10 illustrates another example of how a vehicle generated false alert may arise;

FIG. 11 is a block diagram showing the structure of an area alert management system (AAMS) which can be deployed in a road management system including the road management system of FIGS. 1 to 8;

FIG. 12 illustrates some of the data paths between the AAMS and other system entities in the road management system;

FIG. 13 is a flow diagram illustrating one method of determining whether a vehicle generated alert is a false alert in accordance with the invention;

FIG. 14 illustrates a method of clustering false alerts in accordance with the invention;

FIG. 15 illustrates a method of correlating influence factors for clustered false alerts in accordance with the invention;

FIG. 16 is a schematic diagram illustrating a method of determining a confidence level in a false alert.

### DESCRIPTION OF PREFERRED EMBODIMENTS

The following description is of preferred embodiments by way of example only and without limitation to the combination of features necessary for carrying the invention into effect.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments, but not other embodiments.

It should be understood that the elements shown in the FIGS. may be implemented in various forms of hardware, software or combinations thereof. These elements may be implemented in a combination of hardware and software on one or more appropriately programmed general-purpose devices, which may include a processor, memory and input/output interfaces.

The present description illustrates the principles of the present invention. It will thus be appreciated that those skilled in the art will be able to devise various arrangements that, although not explicitly described or shown herein, embody the principles of the invention and are included within its spirit and scope.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of systems and devices embodying the principles of the invention.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. It is thus regarded that any means that can provide those functionalities are equivalent to those shown herein.

In the following description a reference to an “alarm” such be taken as a reference to an “alert” and vice-versa.

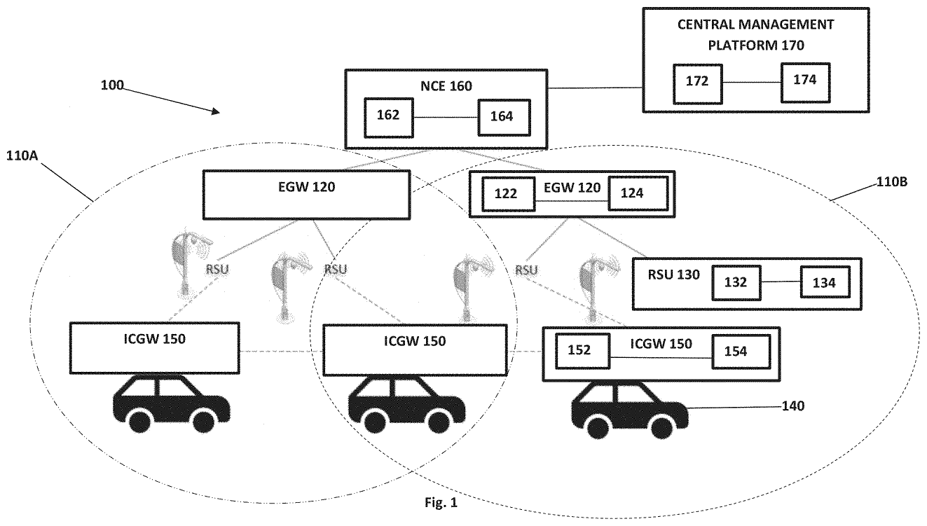

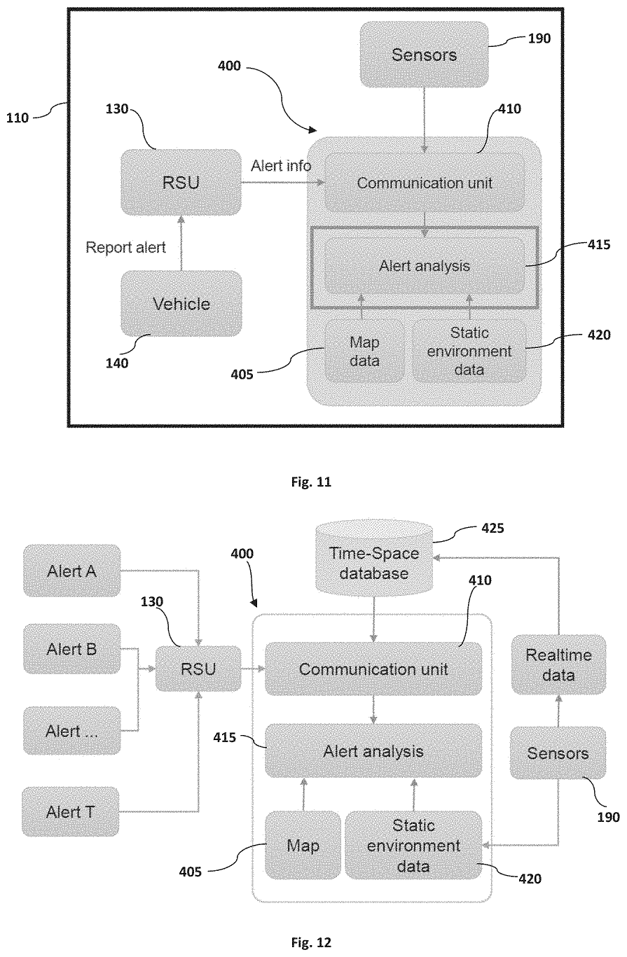

Referring to FIG. 1, provided is a schematic diagram illustrating one embodiment of a system 100 in which the AAMS 400 (FIG. 11) in accordance with the invention may be implemented, although it will be understood that the AAMS 400 in accordance with the invention may be implemented in any suitable road management systems including V2X based road management systems. The system 100 is preferably a communications network-based system 100 arranged as a plurality of defined local geographical areas 110A, B, each defined local geographical area 110A, B being managed by and/or in data communication with a respective edge gateway module (EGW) 120. Each EGW 120 communicates with a respective NCE 160 and each NCE communicates with a central management platform 170.

The defined local geographical areas 110A, B may overlap as shown in FIG. 1, although this is not necessarily the case and it is preferred that any overlaps between adjacent defined local geographical areas 110A, B are arranged to be as small as possible. Each EGAN 120 preferably manages and is in communication with a plurality of roadside units (RSUs) 130. Each RSU 130 is preferably arranged alongside, adjacent or near to any one or more of a road, an intersection, a junction, a pedestrian crossing, a set of traffic lights, etc. such that each RSU has a reasonable line of sight to any vehicles located in or passing its near vicinity.

Vehicles 140 which are configured to operate within the network system 100 are each provisioned with a vehicle on-board data processing unit—hereinafter referred to as an in-car gateway module (ICGW) 150. The ICGW 150 may be a stand-alone unit configured to be installable into a vehicle 140 or it may comprise an existing data processing unit of the vehicle 140 having a memory 152 storing machine-readable instructions and a processor 154 for executing said instructions to cause the ICGW 150 to implement appropriate method steps. The ICGW 150 may comprise a V2X on-board unit (V2X-OBU). Each EGW 120 comprises at least a memory 122 for storing machine-readable instructions and a processor 124 for executing said instructions to cause the EGW 120 to implement appropriate method steps. In a similar manner, each RSU 130 comprises at least a memory 132 for storing machine-readable instructions and a processor 134 for executing said instructions to cause the RSU 130 to implement appropriate method steps.

Among other things, each ICGW 150 is preferably configured to provide V2X communication system access and information exchange with other ICGWs 150 and road infrastructure in the defined local geographical area 110A, B, to collect data from the vehicle on-board modules such as, for example, the speedometer and satellite positioning system, directly or indirectly exchange vehicle collected data with other local ICGWs 150, RSUs 130 and its respective EGW 120, use the vehicle collected data and data received from other local ICGWs 150, RSUs 130 and EGW 120 to determine threats and generate alarms, etc., and receive and issue V2X alarms (alerts) and notifications as well as receive traffic status information and recommendations.

Each EGW 120 is preferably configured to at least coordinate multiple RSUs 130 within its respective defined local geographical area 110A, B, monitor traffic in real-time including monitoring traffic congestion and traffic incidents such as accidents, intelligently implement local traffic management, collect data from local infrastructure such as, for example, traffic lights, sensors, cameras, local ICGWs 150 and RSUs 130 and its respective NCE 160, collect policies from its respective NCE 160, and to use collected data to determine threats and generate alarms, etc. Each EGW 120 may be configured to determine from received and processed data specific data to be transmitted to a specific ICGW 150 in dependence on data received at said EGW 120 indicative of one or more parameters related to or associated with a vehicle of said specific ICGW 150. For example, a parameter such a street location may be utilized by the EGW 120 to determine which vehicles within its local geographical area 110A, B need to receive a specific alert, alarm, action or indication of threat.

A plurality of EGWs 120 are preferably managed by and/or in data communication with a respective NCE 160 and, in turn, a plurality of NCEs 160 are preferably managed by and/or in data communication with a central management platform module 170. The system 100 may comprise only a single central management platform module 170 to cover a large geographical region such as, for example a city, a county or a state. Each NCE 160 comprises at least a memory 162 for storing machine-readable instructions and a processor 164 for executing said instructions to cause the NCE 160 to implement appropriate method steps. Similarly, the central management platform module 170 comprises at least a memory 172 for storing machine-readable instructions and a processor 174 for executing said instructions to cause the central management platform module 170 to implement appropriate method steps.

Each NCE 160 is preferably configured to at least intelligently implement regional traffic management, define and provide new and updated traffic policies to the EGWs 120, and coordinate multiple EGWs 120.

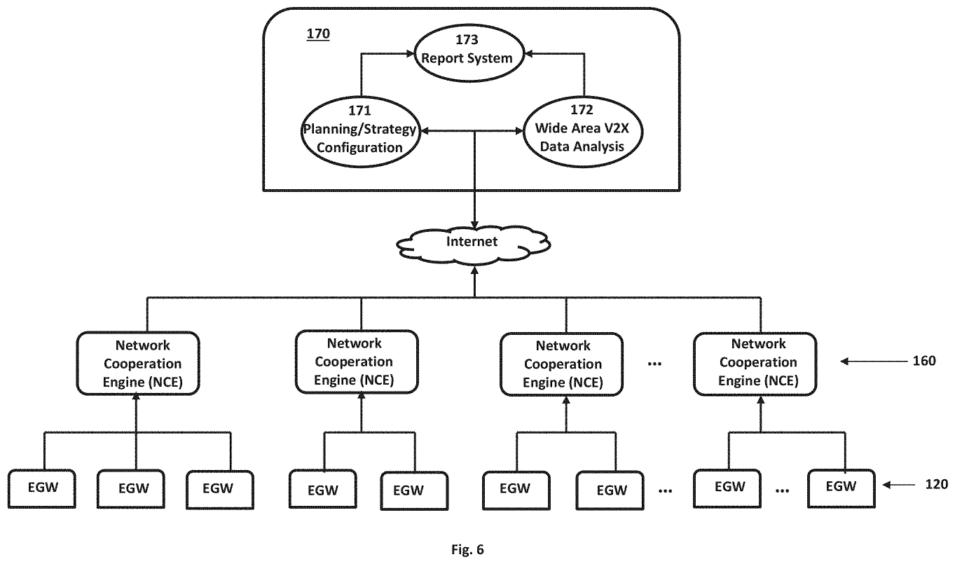

The central management platform module 170 is preferably configured to at least intelligently implement whole network traffic management, define traffic strategies for the NCEs 160 and manage and analyze network wide traffic data. The central management platform module 170 may comprise a cloud-based system and may connect to the NCEs 160 via an IP network such as the internet (FIG. 6) or a virtual private network (VPN).

It will be appreciated that the processing power of the central management platform module 170 will likely be very considerably greater than the processing power of any of the NCE 160, EGW 120, RSU 130 or ICGW 150. Despite this, it is envisaged that the central management platform module 170 will operate on high latency data and/or on long data processing periods to provide information related to, for example, road/traffic strategy and planning rather than time critical generation of alerts, determination of actions and/or determination of threats as will be performed at the local EGW 120 and RSU 130 levels.

For enhancing safety alarm generation and/or threat detection accuracy for vehicles, multiple sources of information such as vehicles, pedestrian devices, roadside infrastructure, and communications network(s), etc. are required at low latency signal processing and delivery levels.

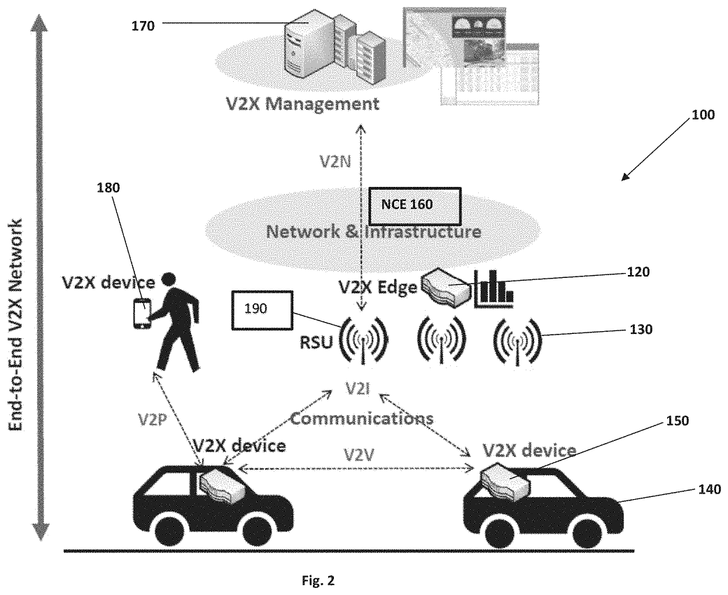

The network system 100 comprises a V2X system which preferably utilizes all local available sources of data including, but not limited to vehicle ICGWs 150, pedestrian devices 180 (FIG. 2), road infrastructure systems and devices 190 (FIG. 2) such as traffic lights, traffic cameras, emergency services databases, local authority databases and the like by way of informing EGWs, preferably in real-time, or at least at ultra-low latency, of events, situations or the like which may be relevant to enabling an EGW 120, a RSU 130 and/or a ICGW 150 to determine a threat to a vehicle 140 or another road user and/or to generate an alarm to a vehicle user or another road user.

As shown more clearly in FIG. 2, each ICGW 150 may utilize one or more standard communications interfaces to communicate with other network entities. For example, the ICGW 150 may utilize V2V to exchange data with other ICGWs 150 and/or utilize V2P to exchange data with pedestrian devices 180 and/or utilize V2I to exchange data with local infrastructure including the RSUs 130. The RSUs 130 and EGWs 120 preferably use V2N to exchange data with each other and higher-level network entities such as the NCEs 160 and the central management platform 170 as will be more fully explained hereinafter. Where appropriate, entities in the network system 100 may also utilize V2D and V2G. As such, provided, as illustrated by FIG. 2, is an end-to-end V2X network system 100 having a multi-tier system architecture which utilizes information and algorithms performed at different tiers of the V2X network system to enable low latency generation of vehicle/road safety alarms and/or low latency determination of vehicle/road threats.

In the V2X network system 100, the EGWs 120 and/or RSUs 130 are configured to process local, real-time and/or low latency data to assist or provide alarms and/or determine threats to road users. The EGWs 120 and/or RSUs 130 will operate on data having a latency of 100 ms or less and preferably 50 ms or less. A low latency is regarded as comprising a data processing and delivery time in the range of 10 ms to 100 ms.

By confining processing of local real-time and/or low latency data to respective EGWs 120 and/or RSUs 130 on behalf of or in conjunction with ICGWs 150 and/or user devices 180, this enables the system 100 to provide or enable time-critical alarm generation and/or threat determination at the local level without the delays inherent of processing such data at higher level entities in the network system 100. A size of the defined geographical area 110A, B is selected such as to enable data from said one or more RSUs 130 and/or from a respective EGW 120 to be transmitted to said ICGWs 150 in real-time or at least at or less than a first, low level of latency.

In one embodiment, the V2X network system 100 provides a communications channel for at least providing additional data to ICGWs 150 to use in addition to on-vehicle data to generate alarms, to determine threats and/or to determine control actions for the vehicle to be implemented manually or autonomously. The V2X channel provided by the network system 100 is an efficient method of getting time-critical data to ICGWs 150 from local external sources that may affect the vehicle and vice versa.

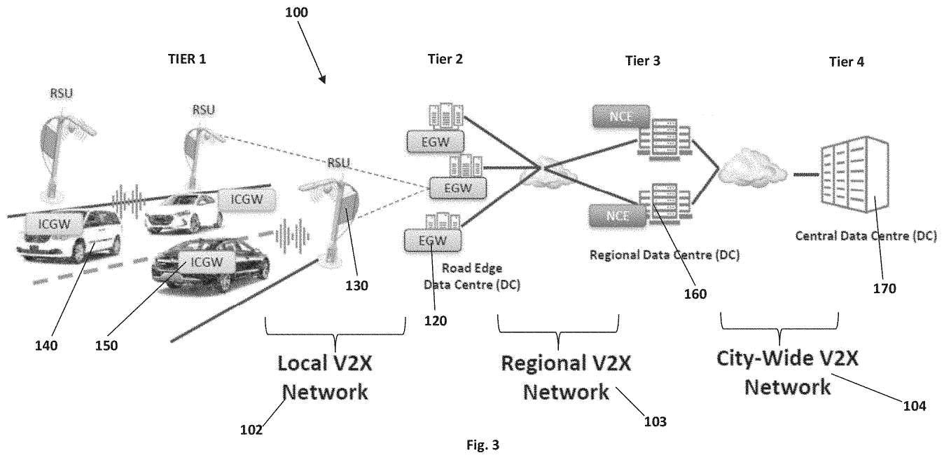

The multi-tiered arrangement of the network system 100 is more clearly seen from FIG. 3. A first tier can be considered as comprising any vehicles 140 with their associated ICGWs 150 within a geographical area of an EGW 120, any other road users such as pedestrians and their associated devices 180 (FIG. 2), street level infrastructure such as smart traffic lights, camera systems, etc. and the RSUs 130. A second tier of the network system 100 comprises the EGWs 120. The first-tier entities are linked to the second-tier entities by what can be considered as a local V2X network 102 where data communications are exchanged using V2I, V2P and V2V. A third tier of the network system 100 can be considered as comprising the NCEs 160 and these are linked to the second-tier entities by what can be considered as a regional V2X network 103 operating over V2I. A fourth tier comprises the central management platform 170 which communicates using V2I over a city-wide, county-wide or state-wide V2X network 104.

The first and second tier entities preferably operate at signal latencies of 100 ms or less and preferably at signal latencies of 50 ms or less. The third-tier entities preferably operate at signal latencies of 1000 ms or less whereas the fourth-tier entity operates at latencies of greater than 1000 ms and nearer to several seconds to minutes and even longer time periods. Consequently, the system 100 generally relates to a multi-tier V2X network architecture or software system to enable low latency road safety V2X alarm detection/threat determination at a local level whilst using information and algorithms performed at different higher-level tiers of the system operating at different, higher latency levels.

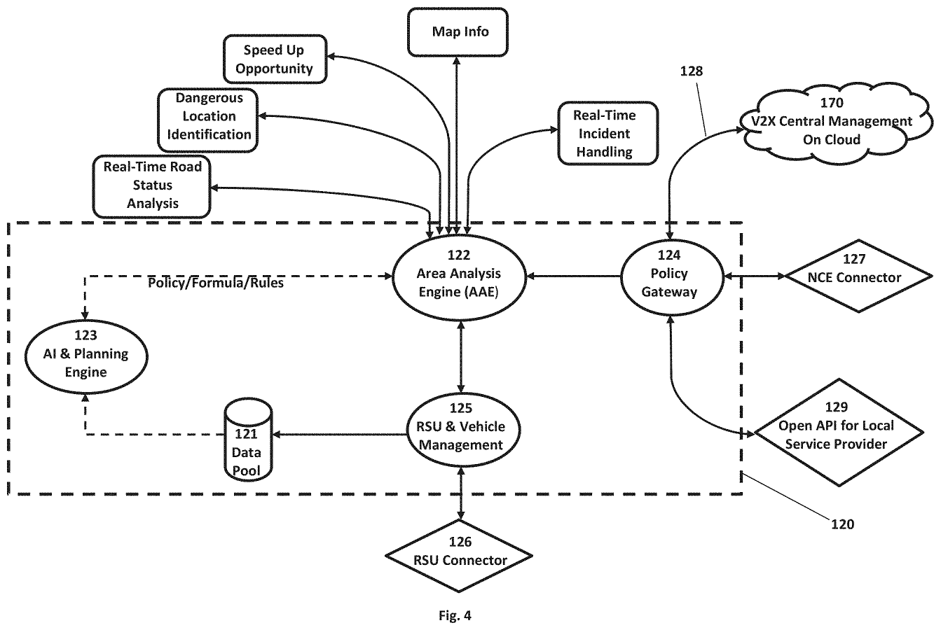

FIG. 4 illustrates the structure of an EGW 120 and its connections to other system entities and some of its information/data inputs. The EGW 120 comprises a database or data pool 121, an area analysis engine module (AAE) 122, an artificial intelligence (AI) planning engine module 123, a policy gateway module 124 and an RSU and vehicle management module 125. Data connectors may include a data connector 126 to one or more RS-Us 130, a data connector 127 to an NCE 160 and optional data connectors 128, 129 to the central management platform 170 and an external service provider. Data inputs to the AAE 122 may include map data, real-time incident handling data, real-time road status analysis data, dangerous location identification data, and vehicle speed-up opportunity data.

The AI and planning engine module 123 is a software module within the EGW 120 configured to aggregate all data generated in the defined geographical area 110A, B of the EGW 120 and process said data using machine learning. The AAE 122 is a software module within the EGW 120 configured to process data generated in the defined geographical area 110A, B to determine any one or more of: real-time status of all roads in the defined geographical area; real-time status of all resources in the defined geographical area; real-time status of all RSUs 130 in the defined geographical area; real-time status of all ICGWs 150 in the defined geographical area; and real-time status of all incidents in the defined geographical area. The policy gateway module 124 is a software module within the EGW 120 configured to receive and configure rules and policies from the NCE 160 or from the central management platform 170, and to receive policy information from a local service using open standard Application Programming Interface (API). For example, local shops could send current retail and promotion information to broadcast to vehicles as low priority promotional information. The RSU and vehicle management module 125 is a software module within the EGW 120 configured to communicate data to the RSUs 130 and ICGWs 150 including real-time status information as described above and to configure at least the RSUs 130 in accordance with any policies received by the EGW 120.

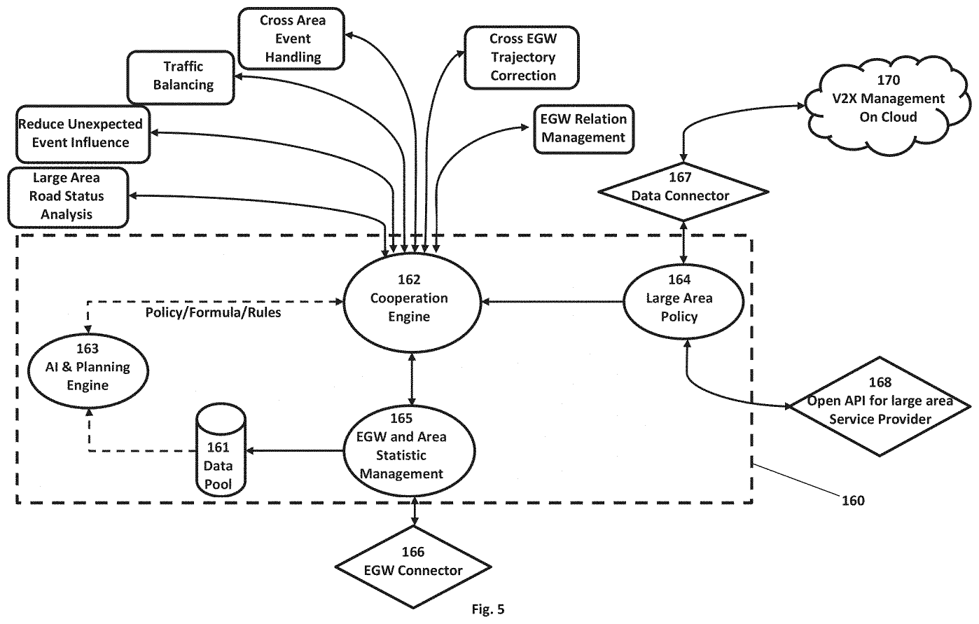

FIG. 5 illustrates the structure of an NCE 160 and its connections to other system entities and some of its information/data inputs. The NCE 160 comprises a database or data pool 161, a cooperation engine module 162, an artificial intelligence (AI) planning engine module 163, a large area policy gateway module 164 and an EGW and area statistics management module 165. Data connectors may include a data connector 166 to one or more EGWs 120, a data connector 167 to the central management platform 170 and optional data connector 168 to a large area external service provider. Data inputs may include EGW relationship data which describes the relationship such as relative positions of one EGW to another, cross EGW trajectory correction data, cross area event handling data, traffic balancing data, reduce unexpected event influence data, and large area road status analysis data.

Each EGW 120 managed by the NCE 160 is configured to communicate its local data for aggregation and extraction by the NCE 160 where the NCE 160 processes the aggregated and extracted data to provide one or more of: road management policy for the EGW defined geographical areas; regional traffic management for the EGW defined geographical areas; and coordinate and manage said plurality of EGWs. The cooperation engine module 162 is a software module within the NCE 160 configured to receive the data inputs and to process the EGW relationship data, the cross EGW trajectory correction data, the cross-area event handling data, traffic, balancing data, and the reduce unexpected event influence data. It may also process the large area road status analysis data. The artificial intelligence (AI) planning engine module 163 is a software module within the NCE 160 configured to take all data uploaded from the EGWs 120 into the data pool 161 and to apply machine learning to such data. The machine learning may comprise supervised learning and may be done offline. One output of the artificial intelligence (AI) planning engine module 163 includes policies, formulas and rules for the cooperation engine module 162 to apply. The artificial intelligence (AI) planning engine module 163 may also be configured to try and determine any relationships between any of the EGWs 120 to assist the cooperation engine module 162 to determine an area or region influenced or affected by, for example, a traffic incident. It will be understood that traffic congestion, for example, in one defined geographical area 110A, B will likely have greater influence or effect on an adjacent local area 110A, B than it would have on a more remote area. The large area policy gateway module 164 is a software module within the NCE 160 configured to receive configuration/rules/policies data from the V2X central management platform 170 and may also be configured to receive policy data from a large area service provider through an open standard API. The EGW and area statistics management module 165 is a software module within the NCE 160 configured to receive data from the cooperation engine module 162 and transmit such data to respective EGWs 120.

FIG. 6 illustrates the structure of the central management platform 170 and its connections to other system entities and some of its information/data inputs. The central management platform module 170 is in direct communication with a plurality of NCEs 160 and indirectly in communication with a plurality of EGWs 120. The central management platform module 170 comprises a planning/strategy configuration module 171, a wide area V2X data analysis module 172 and a report system module 173. The modules 171, 172 and 173 comprise software modules within the central management platform module 170. The central management platform module 170 aggregates and extracts data from the NCEs 160 and the EGWs 120 and processes the aggregated and extracted data to provide one or more of: road management policy for the defined geographical areas 110A, B of the EGWs 120; regional traffic management across NCEs 160 for the defined geographical areas 110A, B of the EGWs 120; directly coordinate said plurality of NCEs 160 and indirectly coordinate said plurality of EGWs 120; provide centralized management of the NCEs 160, EGWs 120 and RSUs 130; provide centralized management of the plurality of data sources located within each defined geographical area 110A, B; provide centralized vehicle to everything (V2X) network management; provide traffic analysis for the defined geographical areas 110A, B; and provide regional traffic analysis for the NCEs 160.

Referring to 7, provided is a flow diagram of the information flows and processes performed by an EGW 120. At 201, statistical data from the ICGWs 150 of all vehicles 140 located within the geographical area 110A, B of the EGW 120 together with, at 202, any incident report data from such ICGWs 150 are transmitted by V2I through a respective RSU 130 to the RSU data connector 126 of the EGW 120. At 203, data collected by a respective RSU 130 from associated data sources within the geographical area 110A, B are transmitted to the data connector 126 of the EGW 120 together with, at 204, any incident data detected by sensors of the RSU 130. At 205, data received at the data connector 126 is aggregated and stored in the data pool 121. Some or all of the aggregated data are passed to the AAE 122 which performs a few functions including, at 206, updating the real-time statuses of all in-area entities. If, at 207, the updating step 206 identifies or detects an emergency incident, data describing the incident are forwarded to 208 to determine, for example, if there is a need to generate an alarm. In the event that it is determined at 208 that there is a need to generate an alarm, a further determination may be made at 209 as to whether or not it is necessary for the alarm to be considered a high priority alarm. In either case, alarm data are communicated via respective RSUs 130 to target vehicles 140. It will be understood that this is done in real-time or at least with very low latency of less than 100 ms. Furthermore, if at 208 it is determined that there is a need to generate an alarm, the method may include at 210 determining whether or not to generate guidance data or even action data for vehicles 140. This may include at 211 determining guidance data or action data for specific vehicles 140 in the geographical area 110A, B. Such guidance data or action data are communicated via respective RSUs 130 to target vehicles 140. Action data may comprise data which causes a target vehicle 140 to autonomously act without human involvement. For example, action data may cause a target vehicle to autonomously slow prior to reaching a pedestrian crossing if pedestrians have been sensed as being on or near the crossing and, more particularly, where pedestrians have been sensed as being on or near the crossing in vulnerable positions.

In addition to determining or detecting at 207 an emergency incident; the AAE 122 may be configured to calculate at 212 useful statistics such as traffic statistics and may include determining at 213 useful statistics to be transmitted to one or more NCEs 160. The statistical data generated at 212 may in turn be used at 214 to calculate a traffic pass time for each road in the geographical area 110A, B, at 215 to calculate potential congestion times, and at 216 calculate other meaningful statistics or parameters for the traffic situation in the geographical area 110A, B. The data generated at each or any of 214, 215 and 216 may also be used generate alarms and/or guidance/actions for targeted vehicles 140. Guidance data and/or action data may also be communicated target vehicles 140 via other vehicles using V2V.

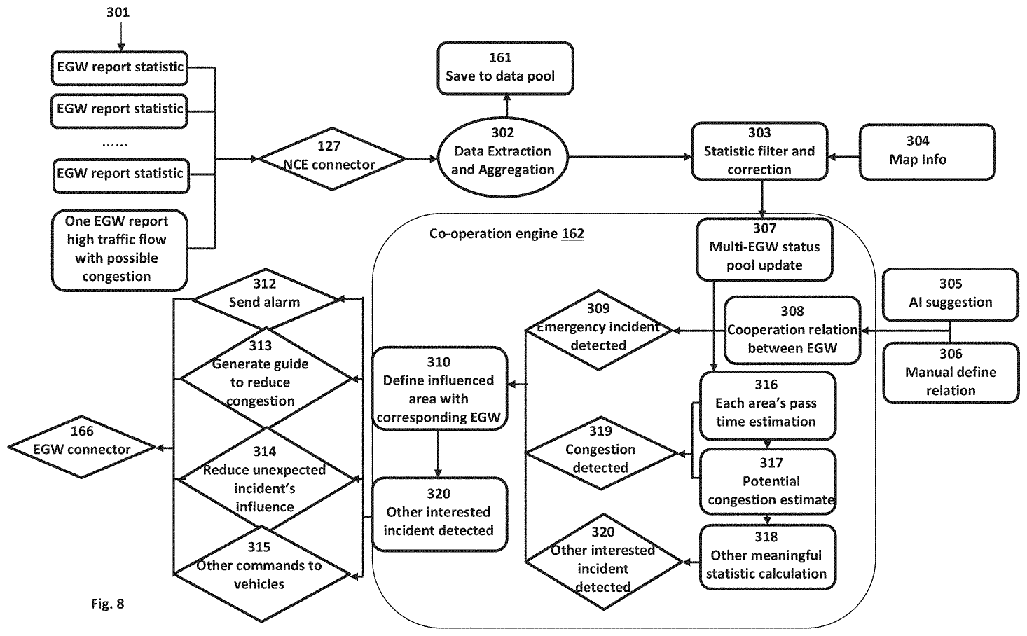

Referring to FIG. 8, provided is a flow diagram of the information flows and processes performed by an NCE 160. At 301, each EGW reports statistical data including, but not limited to, status report data, incident report data and congestion report data and transmits said data to its NCE data connector/interface 127 (NCE EGW data connector 166). At 302, said data is aggregated and stored in the NCE data pool 161. Some or all of said aggregated data are forwarded to the cooperation engine module 162, although, in an optional step at 303, said data may be filtered and corrected. Furthermore, map data may be input at 304. At 305 optional data inputs to the cooperation engine module 162 may include AI suggested inputs from any one of the EGW artificial intelligence (AI) planning engine module 123, the NCE artificial intelligence (AI) planning engine module 163, the central management platform planning/strategy configuration module 171, the wide area V2X data analysis module 172 or the report system module 173. At 306, optional data inputs to the cooperation engine module 162 may include manually defined relationship data such as, for example, the spatial relationships between EGWs 120 and their respective geographical areas 110A, B.

At 307, the cooperation engine module 162 receives multi-EGW status data from the EGW data pools 121. Based on this data and optionally on EGW relationship data received at 308, the cooperation engine module 162 may determine at 309 if any emergency incident has been detected and, if so, to define at 310 the area or areas and corresponding EGWs 120 affected by the incident and to define actions and/or alarms to trigger for each affected EGW 120. The actions and/or alarms may comprise, although are not limited to 312 “send an alarm”; 313 “generate guide to reduce congestion”; 314 “reduce unexpected incident's influence”; and 315 “other commands to vehicles”. Once the actions and/or alarms are determined, these are issued to affected EGWs 120 via the EGW data connector/interface 166.

The cooperation engine module 162 may also use the multi-EGW status data and optionally the EGW relationship data to estimate any one or more of 316 each EGW area's pass time, 317 each EGW area's estimated potential congestion, and 318 other meaningful statistical data. The EGW area's pass time and EGW area's estimated potential congestion can be used at 319 to determine if congestion is detected and to use this data to define at 310 the area or areas and corresponding EGWs 120 affected by the incident and to define actions and/or alarms to trigger for each affected EGW 120. The other meaningful statistical data can be used at 320 to determine any other detected incident and to also use this data to define at 310 the area or areas and corresponding EGWs 120 affected by the incident and to define actions and/or alarms to trigger for each affected EGW 120.

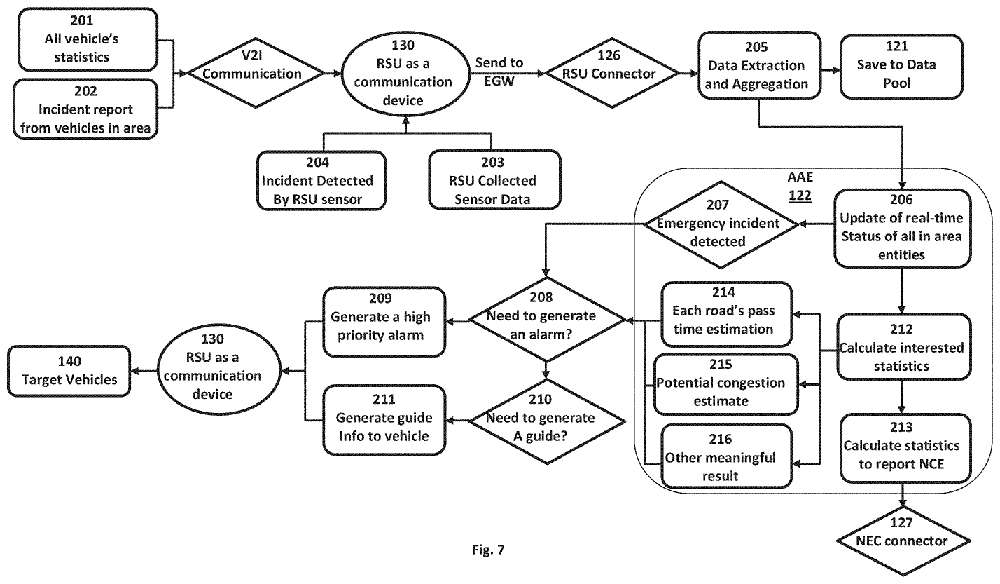

In the following description, the AAMS 400 in accordance with the invention will be described as being implemented in the system 100 of FIGS. 1 to 8 and like numerals will be used to denote like parts. However, it will be understood that the AAMS 400 in accordance with the invention may be implemented in any suitable road management system.

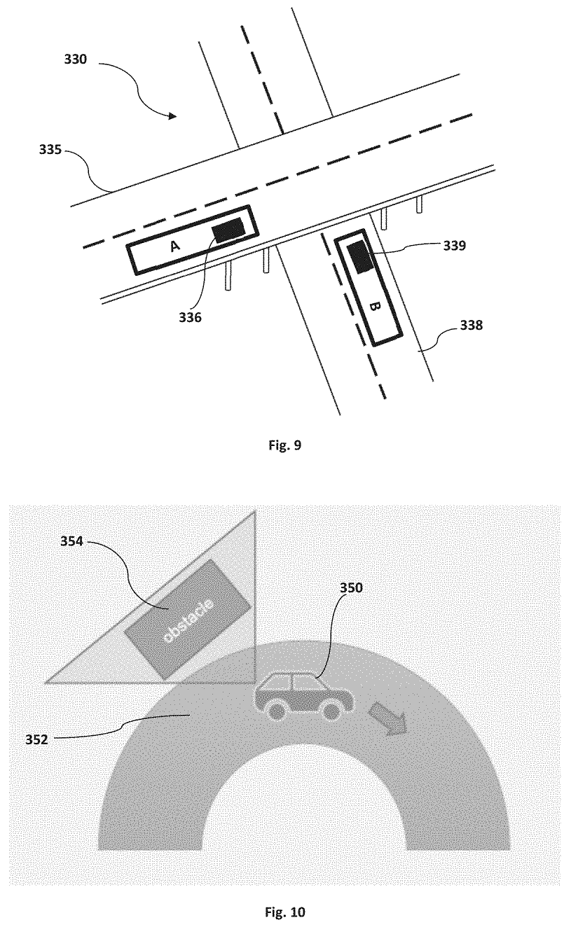

Referring to FIG. 9, shown is an intersection 330 of a first carriageway (road) 335 with a second carriageway 338. However, in this example, the two carriageways 335, 338 do not physically intersect and form a junction because the first carriageway 335 is elevated and crosses over the second passageway 338 such that traffic on the first carriageway 335 does not directly impede traffic on the second carriageway 338 or vice-versa. In contrast, in a scenario where the first and second carriageways 335, 338 do physically intersect to form a junction (not shown), it would be necessary to have traffic control devices such as traffic lights at the junction of the two carriageways 335, 338 to control traffic flows.

In the example scenario of FIG. 9, a first vehicle 336 in box A on the first carriageway 335 may detect the presence of another vehicle 339 in box B on the second carriageway 338 and issue an alert to the driver of the first vehicle 336 to be aware of the near proximity of the second vehicle 339. However, it will be understood that such an alert would be redundant as the detected proximity of the first and second vehicles 336, 339 is not relevant from a traffic management/safety point of view as there is no possibility of the first and second vehicles 336, 339 colliding, for example. The alert would therefore constitute a false alert to the driver of the first vehicle 336. A probability of such a false alert being issued may be higher in the case where the first vehicle 336 has entered the defined geographical area containing the cross-over intersection 330 of the first and second carriageways 335, 338 for the first time and particularly if the first vehicle 336 does not have or has not yet received updated map data and/or static environmental data and/or sensor data for the defined geographical area or at least the area surrounding the cross-over intersection 330. In this example scenario, the first vehicle 336 has limited data by which to process the detected near proximity of the second vehicle 339 and to determine if an alert needs to be issued to the driver. Furthermore, in this example scenario, other vehicles (not shown) not having relevant map data and/or static environmental data and/or sensor data may also issue intersection alerts not only to their respective drivers but to the system 100 entities such as the RSUs 130 and EGWs 120. The generation by vehicles of such false alerts is undesirable for many reasons.

In the example scenario of FIG. 10, a first vehicle 350 is travelling around a curved part of a carriageway 352 or around a roundabout and, as it does so, it detects near proximity of a roadside object or obstacle 354 in one of the vehicle's blind spots and falsely identifies the object or obstacle 354 as another vehicle and issues, in this example scenario, a left-side blind spot alert to the vehicle driver. Once again, in this example scenario, it can be seen that the issued alert is a false alert, issuance of which could have been prevented or at least at a reduced occurrence of such false alerts if vehicles had received relevant map data and/or static environmental data and/or sensor data indicating the presence of the object or obstacle 354.

The AAMS 400 in accordance with the invention is configured to receive vehicle generated alerts and to use any of relevant map data and/or static environmental data and/or sensor data to determine if a vehicle generated alert is a false alert and to then communicate data about or related to the false alert to other vehicles 140 and user devices 180 via RSU 130 in the system 100 so as to reduce or even prevent similar such false alerts being issued thereafter.

Referring now to FIG. 11, shown is a block diagram of the AAMS 400 and its connections to some of the other entities 130, 190 in the system 100. The black box surrounding the AAMS 400 can be considered as defining the defined geographical area 110 containing the at least one RSU 130 but it will be understood that the diagram is not to scale and that the defined geographical area 110 could be much larger than shown and containing within it a plurality of RSUs 130, a plurality of roadside sensors 190 such as road infrastructure systems and devices and at least one EGW (not shown).

The AAMS 400 comprises a map data unit 405 comprising map data for the defined geographical area 110 or at least the area surrounding the at least one RSU 130. The AAMS 400 is shown connected to the at least one RSU 130, although it will be understood that the AAMS 400 may comprise a part of the EGW 120 and may be implemented through machine code stored in the memory 122 and executable by the processor 124 of the EGW 120. In other embodiments, the AAMS 400 may comprise a stand-alone apparatus communicatively connected to the RSU 130 via, for example, the V2X network 102, 103, 104 and communicatively connected to one or more of the roadside sensors 190. Preferably therefore the AAMS 400 has a communication unit 410 for managing communications between the AAMS 400 and the system entities such as the RSUs 130 and roadside sensors 190. The AAMS 400 also has an alert analysis unit 415 configured to receive vehicle generated alerts. The AAMS 400 preferably includes a static environment data unit 420 comprising static environmental data for the defined geographical area 110 or at least the area surrounding the at least one RSU 130.

It will be understood that all or any of the units comprising the AAMS 400 can be implemented by machine code stored in a memory device and executable by a processor.

In a first method in accordance with the invention, the alert analysis unit 415, upon receiving a vehicle generated alert, processes the received vehicle generated alert to determine if the alert is a false alert. The alert analysis unit 415 is configured to use a location associated with the vehicle generated alert to obtain map data from the map data unit for a defined area surrounding the vehicle generated alert location and/or use a location associated with the vehicle generated alert to obtain static environmental data for the defined area surrounding the vehicle generated alert location and/or retrieve sensor data for the defined area surrounding the vehicle generated alert location based on the location and time of the vehicle generated alert. The defined area surrounding the vehicle generated alert location may be of a predetermined size much smaller than the size of the defined geographical area 110 or may have a dynamically determined small size dependent on the relative locations/positions of system entities such as RSUs 130 and/or roadside sensors 190 which are deemed relevant to the generation by a vehicle of the received alert. There are a number of ways in which the size of the area surrounding the vehicle generated alert location is determined either statically or dynamically and this could include taking into account locations and/or clusters of previously determined false alerts.

In any event, the alert analysis unit 415 determines if the received vehicle generated alert is consistent with the obtained and/or retrieved data for the defined area surrounding the vehicle generated alert location. In the example scenario of FIG. 9, the alert analysis system 415 might determine a lack of consistency with relevant map data for a received vehicle generated intersection alert because the first carriageway 335 crosses over the second carriageway 338, i.e., they do not, in fact, intersect each other at a junction. Or, in the example scenario of FIG. 10, the alert analysis system 415 might determine a lack of consistency with relevant static environmental data for a received vehicle generated blind spot alert because the static environmental data includes data defining the position and possibly also the type of roadside object or obstacle 354. The alert analysis unit 415 records that the received vehicle generated alert is a false alert when it is determined that the received vehicle generated alert lacks consistency with the relevant obtained and/or retrieved data for the defined area surrounding the vehicle generated alert location. The alert analysis unit 415 may also employ roadside sensor data for the defined area surrounding the vehicle generated alert location either by itself or in any combination with the relevant map data and the relevant static environmental data. An example scenario may be where the received vehicle generated alert has detected a pedestrian at a road crossing or a cyclist riding a bicycle along an outside margin of a carriageway but where the relevant roadside sensor data show that the detection is in error or that the cause of the detection is no longer present, e.g., the pedestrian has exited the road crossing onto the pavement and the generated alert is a false alert.

Referring to FIG. 12, illustrated are some of the data paths between the AAMS 400 and other system entities in the road management system 100. It can be seen that the AAMS 400 preferably receives vehicle generated alerts via the at least one RSU 130. This has at least the advantage of enabling the RSU 130 to process the alerts in the manner described with respect to the system 100 of FIGS. 1 to 8 as well as enabling the AAMS 400 to process said received vehicle generated alerts to determine whether or not any of such received alerts present as false alerts. The received alerts may comprise alerts of different types denoted, by way of example, as “A”, “B” or “T” in FIG. 12. FIG. 12 also illustrates that the roadside sensors 190 may communicate data to update the static environmental data managed by the static environment unit 420. Furthermore, real-time sensor data or stored sensor data can be communicated to a “time-space” or a “time-location” database 425 which stores roadside sensor data by location and time when generated and possibly also by other parameters such as event type, etc.

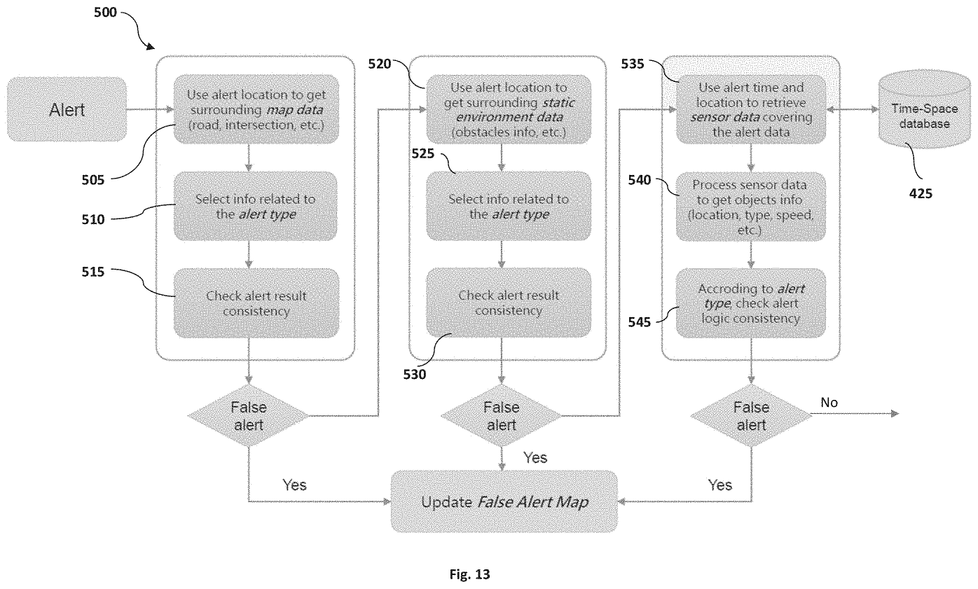

Referring to FIG. 13, shown is a flow diagram illustrating of another method 500 of reducing vehicle generated false alerts in accordance with the invention. In a first step 505 of the method 500; the alert analysis unit 415, upon receiving a vehicle generated alert, uses the location associated with the vehicle generated alert to obtain map data from the map data unit 405 for the defined area surrounding the vehicle generated alert location. The obtained map data may include any of properties and locations of roads, locations and types of intersections, positions and locations of traffic signals, boundaries, and the like. In a second step 510, the alert analysis unit 415 uses the type of the received vehicle generated alert and obtains only map data from the map data unit 405 for the defined area surrounding the vehicle generated alert location that is related or relevant to the type of the received vehicle generated alert. In any event, in a third step 515, the alert analysis unit 415 then determines if the received vehicle generated alert is consistent with the relevant map data for the defined area surrounding the vehicle generated alert location. If, in the third step 515, the alert analysis unit 415 determines a lack of consistency between the received vehicle generated alert and the relevant map data, it records that the received vehicle generated alert is a false alert and generates a false alert map and/or updates the false alert map data in the map data unit 405. The AAMS 400 may also communicate the false alert and/or the false alert map data to the at least one RSU 130 and/or to the one or more ICGWs 150 of vehicles 140 and/or to the one or more V2X, devices 180 in the defined geographical area 110 or in the coverage area of the RSU 130 or in the defined area surrounding the vehicle generated alert location. The updated false alert data may comprise for any false alert any one or more of: location such as global positioning system (GPS) location data; type such as, for example, intersection alert; and/or reason such as “not an intersection” for example.

If, in the third step 515, the alert analysis unit 415 does not determine a lack of consistency between the received vehicle generated alert and the relevant map data, the method moves to a fourth step 520 where the alert analysis unit 415 obtains static environmental data for the defined area surrounding the vehicle generated alert location from the static environment data unit 420. The static environmental data may comprise data defining any feature which is generally non-changing in time such as static objects and obstacles and may include, for example, long standing roadworks and the like. In a fifth step 525, the alert analysis unit 415 uses the type of the received vehicle generated alert and obtains only static environmental data from the static environment data unit 420 for the defined area surrounding the vehicle generated alert location that is related or relevant to the type of the received vehicle generated alert. In any event, in a sixth step 530, the alert analysis unit 415 then determines if the received vehicle generated alert is consistent with the relevant static environmental data for the defined area surrounding the vehicle generated alert location. If, in the sixth step 530, the alert analysis unit 415 determines a lack of consistency between the received vehicle generated alert and the relevant static environmental data, it records that the received vehicle generated alert is a false alert and generates a false alert map and/or updates the false alert map data in the map data unit 405. The AAMS 400 may also communicate the false alert and/or the false alert map data to the at least one RSU 130 and/or to the one or more ICGWs 150 of vehicles 140 and/or to the one or more user devices 180 in the defined geographical area 110 or in the coverage area of the RSU 130 or in the defined area surrounding the vehicle generated alert location.

If in the sixth step 530, the alert analysis unit 415 does not determine a lack of consistency between the received vehicle generated alert and the relevant static environmental data, the method moves to a seventh step 535 where the alert analysis unit 415 retrieves roadside sensor data from one or more of the sensors 190 for the defined area surrounding the vehicle generated alert location based on the location and time of the vehicle generated alert. The roadside sensor data may be retrieved from the time-space database 425. Such data can be processed off-line in the time-space database 425 and/or in the alert analysis unit 415. In an eighth step 540, the alert analysis unit 415 processes the retrieved roadside sensor data to select data relating to any combination of the location, speed, direction and type of objects in the defined area surrounding the vehicle generated alert location. The objects preferably include any other vehicles 140 located within the defined area surrounding the vehicle generated alert location. In any event, in a ninth step 545, the alert analysis unit 415 then determines if the received vehicle generated alert is consistent with the retrieved sensor data. The ninth step 545 of the method may be based on the type of the received vehicle generated alert. If, in the ninth step 545, the alert analysis unit 415 determines a lack of consistency between the received. vehicle generated alert and the relevant sensor data, it records that the received vehicle generated alert is a false alert and generates a false alert map and/or updates the false alert map data in the map data unit 405. The AAMS 400 may also communicate the false alert and/or the false alert map data to the at least one RSU 130 and/or to the one or more ICGWs 150 of vehicles 140 and/or to the one or more user devices 180 in the defined geographical area 110 or in the coverage area of the RSU 130 or in the defined area surrounding the vehicle generated alert location.

If in the ninth step 545, the alert analysis unit 415 does not determine a lack of consistency between the received vehicle generated alert and the relevant sensor data, the method 500 outputs that the received vehicle generated alert is not a false alert.

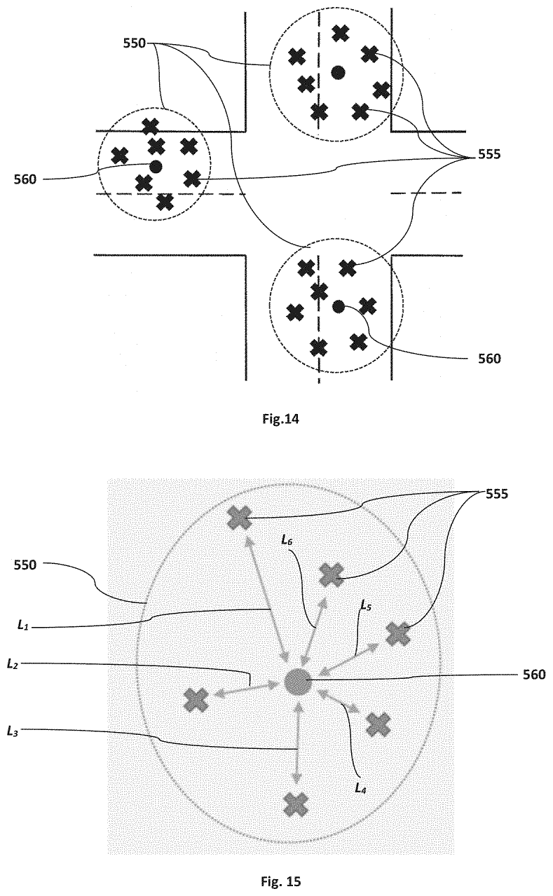

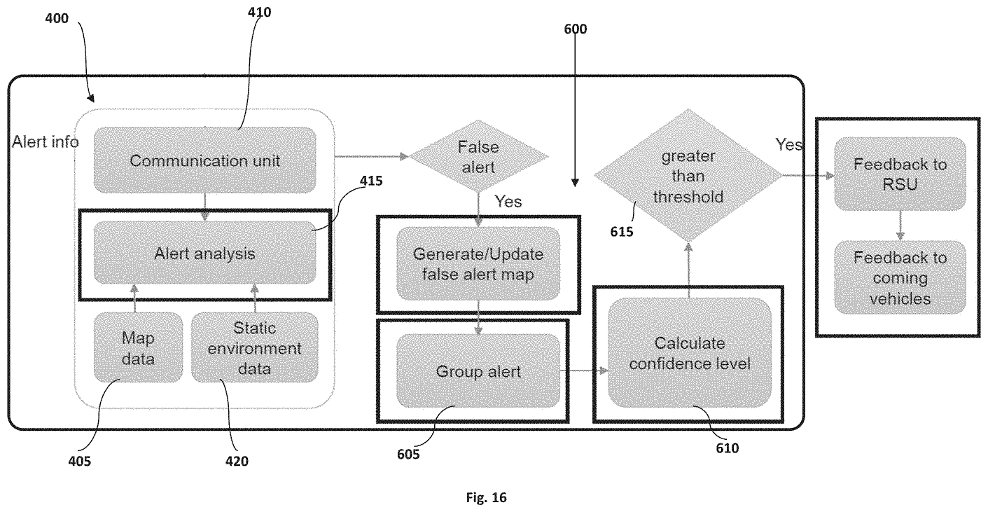

In an enhancement of the described methods according to the invention as illustrated by FIGS. 14 to 16, it is preferred in a first step 605 of the enhanced method 600 (FIG. 16) to group false alerts by alert type in respective clusters 550 (FIG. 14) within the defined geographical area 110 or within another defined area within the defined geographical area 110. The another defined area is smaller than the defined geographical area 110 and may comprise an area the same as or similar to the defined area surrounding a vehicle generated alert location. The enhanced method 600 may include determining a parameter for each respective cluster 550 of false alerts.

FIG. 14 illustrates a method of clustering the false alerts in accordance with the enhanced method 600 of the invention. In FIG. 14, the dashed-line circles delimit the sizes of the respective clusters 550 of false alerts, the “Xes” 555 represent the locations of the false alerts within each cluster 550 and the round black spots are indicative of a determined parameter for each the clusters 550 of false alerts. The parameter preferably comprises a location centroid 560 for a respective cluster 550.

The alert analysis unit 415 is preferably configured to group false alerts by alert type in the respective clusters 550 using a density-based spatial clustering of applications with noise (DBSCAN) algorithm using as input data one of more of: false alert location latitude data; false alert location longitude data; speed of vehicle associated with the false alert; direction of vehicle associated with the false alert; or road lane data of vehicle associated with the false alert. Other false alert data inputs may be included.

The alert analysis unit 415 is preferably configured to determine the centroid 560 for each respective cluster 550 using a K-means algorithm.

In a second step 610 of the enhanced method 600, the alert analysis unit 415 is configured to determine a confidence level C for each respective cluster 550 of false alerts based on a correlation of geographical information R for the false alerts in each respective cluster 550 and a correlation of influence factors I for the false alerts in each respective cluster 550.

The correlation of geographical information R for the false alerts in each respective cluster 550 is preferably obtained from:

R=1−Avg(L₁,L₂,L₃, . . . L_{N})/Max(L₁,L₂,L₃, . . . L_{N})

where N is the number of false alerts in the cluster 550;

L_{N} is the deviation or distance of each false alert from the centroid 560 of the cluster 550; and

0<R<1.

The closer R is to 1, the higher the confidence level C. Multiple false alert locations which are close together will result in a higher value of R in the range from 0 to 1. Multiple false alert locations at a connected area with a same property such as a same carriageway lane will also result in a higher value of R in the range from 0 to 1.

In FIG. 15, N=6, i.e., L₁, L₂, L₃, L₄, L₅ and L₆ comprise the respective deviations or distances of the six false alert locations respectively denoted as “X” from the centroid 560 of the cluster 550.

The correlation of influence factors I for the false alerts in each respective cluster 550 is preferably obtained from:

$$I = {\prod }_{j = 1}^{M} ( 1 - \frac{{\sum }_{i = 1}^{N} \vert {S}_{{j}_{i}} - {S}_{{j}_{avg}} \vert}{{\sum }_{i = 1}^{N} {S}_{{j}_{i}}} )$$

where M is the number of the influence factors;

where N is the number of false alerts in the cluster 550;

Sⱼ is an influence factor;

Sⱼ_{_{avg}}=Avg(Sⱼ_{₁}, Sⱼ_{₂}, Sⱼ_{₃}, . . . , Sⱼ_{_{N}}) where Sⱼ_{_{avg}} is the average value of Sⱼ; and

0<C<1.

The closer I is to 1, the higher the confidence level C. The greater the similarity of the influence factors S for the false alerts in each respective cluster 550, the higher the value of I.

It will be understood, however, that there is no limit on the number of influence factors S which may be utilized as, the greater the number of influence factors S, the more accurate the result obtained.

For example, in FIG. 15, where N=6, considering speed S₁ and direction S₂ as the only two influence factors, where S₁_{_{avg}} is the average of the speeds (S₁_{₁}, S₁_{₂}, S₁_{₃}, . . . S₁_{₆}) of the vehicles for the false alerts in the cluster and S₂_{_{avg}} is the average of the directions (S₂_{₁}, S₂_{₂}, S₂_{₃}, . . . S₂_{₆}) of the vehicles for the false alerts in the cluster, so the correlation of influence factors I formula:

$$I = {\prod }_{j = 1}^{2} ( 1 - \frac{{\sum }_{i = 1}^{6} \vert {S}_{{j}_{i}} - {S}_{{j}_{avg}} \vert}{{\sum }_{i = 1}^{6} {S}_{{j}_{i}}} )$$

The confidence level C of each cluster 550 is preferably determined from C=R×I and the alert analysis unit 415 is configured in a third step 615 of the enhanced method 600 to compare the confidence level C of each cluster 550 to a predetermined, calculated or selected threshold H such that where C>H the AAMS 400 will then communicate false alert related data of the respective cluster 550 to the at least one RSU 130 and/or to one or more ICGWs 150 of vehicles 140 in the defined geographical area 110 or in the coverage area of the RSU 130 or in the defined area surrounding the vehicle generated alert location to the one or more vehicle on-board data processing units of the respective cluster. In one embodiment, where C>H for a cluster 550, the AAMS 400 will communicate false alert related data of the respective cluster 550 to the at least one RSU 130 which then broadcasts said data to the ICGWs 150 of vehicles 140 and/or to the user devices 180 in the defined geographical area 110. Equipped with the broadcast information, the ICGWs 150 of the vehicles 140 and/or the user devices 180 can locally make a decision in a manner which reduces or may even prevent the occurrences of false alerts. Consequently, each ICGW 150 and/or the user devices 180 can make a decision based not only on its local awareness of the environment but also taking into account data relating to false alerts previously generated by other ICGWs and/or user devices 180 thereby enabling the occurrences of such false alerts to be at least reduced.

The road management system 100 including the AAMS 400 may comprise a Vehicle-to-Everything (V2X) software system. The road management system 100 including the AAMS 400 may comprise a road safety management system.

One significant advantage of the system 100 of the invention including the AAMS 400 is that, by reducing or preventing the issuance of false alerts, it considerably reduces communication bandwidth between entities within the system 100 and reduces the computational load on entities such as RSUs 130 and EGWs 120.

The apparatuses described above may be implemented at least in part in software. Those skilled in the art will appreciate that the apparatuses described above may be implemented at least in part using general purpose computer equipment or using bespoke equipment.

Here, aspects of the methods and apparatuses described herein can be executed on any apparatus comprising the communication system. Program aspects of the technology can be thought of as “products” or “articles of manufacture” typically in the form of executable code and/or associated data that is carried on or embodied in a type of machine readable medium. “Storage” type media include any or all of the memory of the mobile stations, computers, processors or the like, or associated modules thereof, such as various semiconductor memories, tape drives, disk drives, and the like, which may provide storage at any time for the software programming. All or portions of the software may at times be communicated through the Internet or various other telecommunications networks. Such communications, for example, may enable loading of the software from one computer or processor into another computer or processor. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible non-transitory “storage” media, terms such as computer or machine “readable medium” refer to any medium that participates in providing instructions to a processor for execution.

While the invention has been illustrated and described in detail in the drawings and foregoing description, the same is to be considered as illustrative and not restrictive in character, it being understood that only exemplary embodiments have been shown and described and do not limit the scope of the invention in any manner. It can be appreciated that any of the features described herein may be used with any embodiment. The illustrative embodiments are not exclusive of each other or of other embodiments not recited herein. Accordingly, the invention also provides embodiments that comprise combinations of one or more of the illustrative embodiments described above. Modifications and variations of the invention as herein set forth can be made without departing from the spirit and scope thereof, and, therefore, only such limitations should be imposed as are indicated by the appended claims.

In the claims which follow and in the preceding description of the invention, except where the context requires otherwise due to express language or necessary implication, the word “comprise” or variations such as “comprises” or “comprising” is used in an inclusive sense, i.e., to specify the presence of the stated features but not to preclude the presence or addition of further features in various embodiments of the invention.

It is to be understood that, if any prior art publication is referred to herein, such reference does not constitute an admission that the publication forms a part of the common general knowledge in the art.

1. An area alert management system (AAMS) for reducing false alerts in a road management system, the AAMS comprising:
a map data unit comprising map data for a defined geographical area, said defined geographical area including at least one roadside unit (RSU) configured to receive data from one or more vehicle on-board data processing units of vehicles located within said defined geographical area, said one or more vehicle on-board data processing units configured to autonomously determine alerts;
an alert analysis unit configured to receive vehicle generated alerts; and
a static environment data unit comprising static environmental data for said defined geographical area;
wherein the AAMS is configured to receive data from a plurality of sources located within said defined geographical area;
wherein, upon receiving a vehicle generated alert, the alert analysis unit is configured to:
use a location associated with the vehicle generated alert to obtain map data from the map data unit for a defined area surrounding the vehicle generated alert location and/or use a location associated with the vehicle generated alert to obtain static environmental data for the defined area surrounding the vehicle generated alert location and/or retrieve sensor data for the defined area surrounding the vehicle generated alert location based on the location and time of the vehicle generated alert;
determine if the received vehicle generated alert is consistent with the obtained and/or retrieved data for the defined area surrounding the vehicle generated alert location; and
determine that the received vehicle generated alert is a false alert if a determination is made that the received vehicle generated alert is not consistent with the obtained and/or retrieved data for the defined area surrounding the vehicle generated alert location.

2. An area alert management system (AAMS) for reducing false alerts in a road management system, the AAMS comprising:
a map data unit comprising map data for a defined geographical area, said defined geographical area including at least one roadside unit (RSU) configured to receive data from one or more vehicle on-board data processing units of vehicles located within said defined geographical area, said one or more vehicle on-board data processing units configured to autonomously determine alerts; and
an alert analysis unit configured to receive vehicle generated alerts;
wherein, upon receiving a vehicle generated alert, the alert analysis unit is configured to:
use a location associated with the vehicle generated alert to obtain map data from the map data unit for a defined area surrounding the vehicle generated alert location;
determine if the received vehicle generated alert is consistent with map data for the defined area surrounding the vehicle generated alert location; and
determine that the received vehicle generated alert is a false alert if a determination is made that the received vehicle generated alert is not consistent with the map data for the defined area surrounding the vehicle generated alert location.

3. The area alert management system (AAMS) of claim 2, wherein, on determining that the received vehicle generated alert is a false alert, the AAMS generates false alert map data or updates false alert map data and communicates the false alert and/or the false alert map data to the at least one RSU and/or to the one or more vehicle on-board data processing units.

4. The area alert management system (AAMS) of claim 2, wherein the alert analysis unit, upon receiving a vehicle generated alert, is configured to use a type of the vehicle generated alert and to obtain only map data from the map data unit for the defined area surrounding the vehicle generated alert location that is related to the type of the vehicle generated alert.

5. The area alert management system (AAMS) of claim 2, wherein the AAMS includes a static environment data unit comprising static environmental data for said defined geographical area, and, wherein, upon determining that the received vehicle generated alert is consistent with the obtained map data for the defined area surrounding the vehicle generated alert location, the alert analysis unit is configured to:
obtain static environmental data for the defined area surrounding the vehicle generated alert location;
determine if the received vehicle generated alert is consistent with the static environmental data for the defined area surrounding the vehicle generated alert location; and
determine that the received vehicle generated alert is a false alert if a determination is made that the received vehicle generated alert is not consistent with the static environmental data for the defined area surrounding the vehicle generated alert location.

6. The area alert management system (AAMS) of claim 5, wherein, on determining that the received vehicle generated alert is a false alert, the AAMS generates false alert map data or updates false alert map data and communicates the false alert and/or the false alert map data to the at least one RSU and/or to the one or more vehicle on-board data processing units.

7. The area alert management system (AAMS) of claim 5, wherein the alert analysis unit, upon receiving a vehicle generated alert, is configured to use a type of the vehicle generated alert and to obtain only static environmental data from the static environment data unit for the defined area surrounding the vehicle generated alert location that is related to the type of the vehicle generated alert.

8. The area alert management system (AAMS) of claim 5, wherein the AAMS is configured to receive data from a plurality of sources located within said defined geographical area, and, wherein; upon determining that the received vehicle generated alert is consistent with the obtained static environmental data for the defined area surrounding the vehicle generated alert location, the alert analysis unit is configured to:
retrieve sensor data for the defined area surrounding the vehicle generated alert location based on the location and time of the vehicle generated alert;
determine if the received vehicle generated alert is consistent with the retrieved sensor data for the defined area surrounding the vehicle generated alert location; and
determine that the received vehicle generated alert is a false alert if a determination is made that the received vehicle generated alert is not consistent with the retrieved sensor data.

9. The area alert management system (AAMS) of claim 8, wherein, on determining that the received vehicle generated alert is a false alert, the AAMS generates false alert map data or updates false alert map data and communicates the false alert and/or the false alert map data to the at least one RSU and/or to the one or more vehicle on-board data processing units.

10. The area alert management system (AAMS) of claim 8, wherein the alert analysis unit, upon receiving a vehicle generated alert, is configured to use the type of the vehicle generated alert and to retrieve only processed sensor data for the defined area surrounding the vehicle generated alert location that is related to the type of the vehicle generated alert.

11. The area alert management system (AAMS) of claim 2, wherein the alert analysis unit is configured to:
group false alerts by alert type in respective clusters within the defined geographical area or another defined area within the defined geographical area; and
determine a parameter for each respective cluster of false alerts.

12. The area alert management system (AAMS) of claim 11, wherein the alert analysis unit is configured to group false alerts by alert type in respective clusters using a density-based spatial clustering of applications with noise (DBSCAN) algorithm using as input data one of more of: false alert location latitude data; false alert location longitude data; speed of vehicle associated with the false alert; direction of vehicle associated with the false alert; or road lane data of vehicle associated with the false alert.

13. The area alert management system (AAMS) of claim 11, wherein the parameter comprises a location centroid for a respective cluster.

14. The area alert management system (AAMS) of claim 13, wherein the alert analysis unit is configured to determine the centroid for each respective cluster using a K-means algorithm.

15. The area alert management system (AAMS) of claim 11, wherein the alert analysis unit is configured to determine a confidence level C for each respective cluster of false alerts based on a correlation of geographical information R for the false alerts in each respective cluster and a correlation of influence factors I for the false alerts in each respective cluster.

16. The area alert management system (AAMS) of claim 15, wherein the correlation of geographical information R for the false alerts in each respective cluster is obtained from:
R=1−Avg(L₁, L₂, L₃, . . . L_{N})/Max(L₁, L₂, L₃, . . . L_{N})
where N is the number of false alerts in the cluster; and
L_{N} is the deviation of each false alert from the centroid of the cluster.

17. The area alert management system (AAMS) of claim 15, wherein the correlation of influence factors I for the false alerts in each respective cluster is obtained from:
$$I = {\prod }_{j = 1}^{M} ( 1 - \frac{{\sum }_{i = 1}^{N} \vert {S}_{{j}_{i}} - {S}_{{j}_{avg}} \vert}{{\sum }_{i = 1}^{N} {S}_{{j}_{i}}} )$$
where M is the number of the influence factors;
where N is the number of false alerts in the cluster;
Sⱼ is an influence factor;
Sⱼ_{_{avg}}=Avg(Sⱼ_{₁}, Sⱼ_{₂}, Sⱼ_{₃}, . . . , Sⱼ_{_{N}}), where Sⱼ_{_{avg}} is the average value of Sⱼ.

18. The area alert management system (AAMS) of claim 17, wherein the confidence level C of each cluster is determined from C=R×I and the alert analysis unit is configured to compare the confidence level C of each cluster to a predetermined, calculated or selected threshold H such that where C>H the AAMS will communicate false alert related data of the respective cluster to the at least one RSU and/or to the one or more vehicle on-board data processing units of the respective cluster and/or to all vehicle on-board data processing units located within the defined geographical area.

19. A method of determining if an alert is a false alert in a road management system having an area alert management system (AAMS) including a map data unit comprising map data for a defined geographical area and a static environment data unit comprising static environmental data for said defined geographical area, the AAMS being configured to receive data from a plurality of sources located within said defined geographical area, said defined geographical area including at least one roadside unit (RSU) configured to receive data from one or more vehicle on-board data processing units of vehicles located within said defined geographical area, said one or more vehicle on-board data processing units configured to autonomously determine alerts, the method comprising the steps of:
receiving a vehicle generated alert;
using a location associated with the vehicle generated alert to obtain map data from the map data unit for a defined area surrounding the vehicle generated alert location and/or using a location associated with the vehicle generated alert to obtain static environmental data for the defined area surrounding the vehicle generated alert location and/or retrieving sensor data for the defined area surrounding the vehicle generated alert location based on the location and time of the vehicle generated alert;
determining if the received vehicle generated alert is consistent with the obtained and/or retrieved data for the defined area surrounding the vehicle generated alert location; and
determining that the received vehicle generated alert is a false alert if a determination is made that the received vehicle generated alert is not consistent with the obtained and/or retrieved data for the defined area surrounding the vehicle generated alert location.
